(19) United States
(12) Patent Application Publication
(10) Pub. No.: US 2002/0176473 A1
(43) Pub. Date: Nov. 28, 2002

(54) Wavelength selectable, controlled chirp, semiconductor laser

(76) Inventor: Aram Mooradian, Sunnyvale, CA (US)

Correspondence Address: FULBRIGHT & JAWORSKI, 865 S. Figueroa Street, 29th Floor, Los Angeles, CA, 90017, US

(21) Appl. No.: 09/865,078

(22) Filed: May 23, 2001

(51) Int. Cl. H01S 3/08

(52) U.S. Cl. 372/92; 257/92

(57) ABSTRACT

A wavelength selectable, controlled chirp, semiconductor laser system is provided. By coupling a passive cavity, including an external output mirror with a selected reflectivity, to the active cavity of a laser device, chirp is reduced by approximately the ratio of the length of the active cavity to the length of the passive cavity. In such a device, changing the length of the passive cavity by manipulating the position of the output mirror allows for selecting an output wavelength of the laser device.

### FIELD OF THE INVENTION

This invention relates generally to an electro-optical device and, more particularly, to a tunable surface emitting semiconductor laser.

### BACKGROUND OF THE INVENTION

Semiconductor lasers that can be tuned to specific wavelengths for application in Dense Wavelength Division Multiplexed fiber optical communications have been long sought after. Distributed Feedback Diode (DFB) lasers have been used extensively for such applications. These lasers use an embedded grating placed along the gain length of edge-emitting devices to control the output to certain discrete wavelengths that have some small degree of tuning due to temperature changes. Several other types of tunable semiconductor laser devices use sampled grating structures in which injected carriers can be used to change the peak transmission to any of a number of discrete wavelengths. All of these devices are edge emitting diode lasers and are usually run continuously in conjunction with an external modulator to avoid the spectral “chirp” that occurs when a diode laser is directly modulated. This “chirp” refers to the change in wavelength that occurs during the electrical driving pulse and is due to the change in refractive index from injected electrons that substantively change the optical resonator length and therefore the output wavelength in time.

Transmitting digital optical signals from a conventional pulsed diode laser over a fiber is limited by optical dispersion over the fiber that can temporally broaden a chirped optical pulse resulting in a limited data rate and/or shorter distance of signal propagation as the pulses broaden and overlap as they propagate down the fiber. Typically, the source of chirp in a conventional diode laser comes from thermal and electronic changes to the refractive index in the active resonator region of the diode laser that results in a change in the optical length of its resonant cavity. The change in the refractive index occurs over the entire gain length of the diode laser that normally encompasses the entire optical resonant cavity length. Prior work on external-cavity, edge-emitting diode lasers has shown that there is a reduction of chirp by the presence of an unloaded portion of the external cavity. However, in order to maintain a fast frequency response for required data rates (10's of GHz), the total optical cavity length of the device must remain small, typically a few mm or less, which can be impractical for edge emitting, external cavity diode lasers. Extended cavity surface emitting lasers with their much shorter gain lengths can provide adequate frequency response as well as a reduced or controlled frequency chirp for high data-rate fiber transmission applications.

Conventional vertical cavity surface-emitting lasers (VCSELs) typically have two flat resonator cavity mirrors formed onto the two outer sides of a layered quantum-well gain structure. The output chirp from such conventional VCSELs cannot be easily controlled. Currently, chirp is controlled in some VCSELS by placing one of the two laser cavity mirrors more distant from the gain region than in a conventional VCSEL. The curvature of the mirror and spacing from the active region may support a fundamental spatial mode. Such a device is called a VECSEL (Vertical Extended Cavity Surface Emitting Laser). The extended resonator that is formed can have various electro-optic and filter elements inserted to control the output.

A number of conventional approaches have been used to provide discrete and tunable frequencies for wavelength division multiplexed (WDM) communication applications. Several individual DFB diode lasers are used with selected fixed wavelengths spaced by about 100 GHz or 50 GHz as transmitter sources. These laser devices are not generally tunable over an extensive wavelength range and, thus, one laser is used for each channel of a WDM system. These devices are generally temperature stabilized in order to maintain the wavelength at an ITU grid frequency. Several solutions to provide tunable sources include: (1) using electrostatically deformable membrane mirrors to form an external cavity to continuously tune a surface emitting semiconductor laser; (2) providing a linear array of DFB lasers that operate at different wavelengths capable of being switched into a single waveguide by use of electrically controlled waveguide switches; (3) thermally tuned DFB lasers in which the temperature change of the device alters the resonant wavelength of the grating, thereby altering the operating wavelength of the device; (4) sampled grating DFB lasers in which a number of different grating sections are contained in a single laser cavity and each are separately excited and tuned thermally by the injection current changes; (5) a Distributed Bragg Grating (DBG) device in which a passive grating section adjacent to the gain region is thermally tuned by an injection current to control the wavelength of the laser; (6) a Sampled Coupled Grating Reflector (SCGR) DBR which consists of a gain section, a coupled section, a phase tuning section and a reflector section and (7) external cavity controlled edge-emitting diode lasers. Most of these laser devices use external modulators to avoid the frequency chirp associated with direct modulation. For example, in addition to the above described tunable lasers, U.S. Pat. No. 5,684,623 to King and Melton “Narrow-Band Tunable Optical Source,” describes a three-reflector laser system. A first reflector and a second reflector define a laser cavity that contains a laser gain medium. A third reflector and the second reflector define an external cavity. The distance between the second and third reflectors is adjustable via thermal expansion or a piezoelectric stack to tune the resonant frequency of the external cavity.

All these schemes are either difficult to manufacture or cannot meet all of the communication system performance requirements. As a result, an improved surface emitting laser device with a low manufacturing cost, absolute frequency control, and a low or controlled spectral chirp at modulation rates above several GHz is desirable.

### SUMMARY OF THE INVENTION

The invention provides a reduced-chirp semiconductor laser device. The device includes an active cavity (including an active gain region disposed between a first and second mirrors). The active cavity is characterized by an active cavity chirp value. The device also includes a passive cavity (including a substantially optically transparent passive cavity material disposed between the second mirror and a third mirror). The third mirror reflectivity and the passive cavity length are adapted to reduce the chirp of the laser device by substantially at least a factor of two over the active cavity chirp.

The invention also provides a method for making a reduced chirp laser device by selecting: (1) an active cavity mirror reflectivity; (2) a passive cavity mirror reflectivity; and (3) a passive cavity length so that the chirp of the device is reduced below a desired level without increasing the laser response time above a selected value.

### BRIEF DESCRIPTION OF THE DRAWINGS

The foregoing and other objects, features, and advantages of the invention will be apparent from the more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 shows a cross sectional schematic diagram of one embodiment of a vertical coupled-cavity surface emitting semiconductor laser according to the present invention.

FIG. 2 shows a cross sectional schematic diagram of an alternative embodiment of the present invention showing the passive cavity to be primarily made up of air.

FIGS. 3A-C show a mirror mount assembly that may be employed to provide micro-motion to adjust the position of an output mirror prior to fixing the position of the mirror, according to an embodiment of the present invention. FIG. 3A shows a top view of the mirror mount assembly. FIG. 3B shows a side view of the mirror mount assembly. FIG. 3C illustrates the operation of the mirror mount assembly shown in FIG. 3B.

FIG. 4 illustrates an exemplary spectral diagram illustrating the various concepts of frequency control of an embodiment of the present invention.

### DETAILED DESCRIPTION OF THE INVENTION

The present invention uses a surface-emitting laser whose output is controlled by an external resonator mirror to select the output wavelength to a desired frequency, for example, one of any of the grid wavelengths specified by the International Telecommunications Union (“ITU”) of Geneva, Switzerland. The laser device is comprised of an active laser cavity and a passive laser cavity. The active cavity contains a gain medium for generating light. While light travels within the passive cavity, it does not contain an active gain medium and light is not generated in the passive cavity. These devices have greatly reduced chirp over a directly modulated edge-emitting diode laser because the refractive index changes in the active cavity are restricted to a small path length compared to the overall length of the laser cavity including the passive cavity. Ratios of passive to active cavity lengths can range from 10:1 to 10,000:1 or more. In these devices, chirp is reduced by approximately the same ratio over devices that do not contain a passive cavity. That is, the overall chirp of a device with a passive cavity is much lower than the chirp value characterizing the active cavity alone.

The typical active cavity lengths for surface emitting lasers are about one to two microns, while the passive cavity length of the present invention is between less than one hundred μm to a few mm. Although the response time of a laser is inversely proportional to the total optical cavity length, a length in this range allows for direct amplitude modulation at rates of more than several GHz. Lasers with shorter optical cavities take less time to reach steady state than those with longer optical cavities. This modulation speed is limited by the cavity response time that is determined by the cavity lifetime and the stimulated emission rate. In addition to the reduction of chirp, it is also possible to control the chirp by the introduction of an intracavity electro-optical element that can be electronically driven to temporally control the output wavelength during the pulse to provide compensation of the existing dispersion in certain fibers.

The present invention provides an output with a fixed but selectable wavelength and a controlled or reduced chirp under high-speed modulation from a surface emitting semiconductor laser. The selected wavelength can be centered at any of the ITU wavelengths by rigidly adjusting the output mirror to set the cavity length to a desired length. The temperature-induced shift of the fixed wavelength defined by the longitudinal modes of the passive cavity per degree Centigrade is less than several tens of MHz from both the change in the optical length of the semiconductor gain region as well as the passive cavity. The passive cavity structure can be made from any of a number of well known, low-coefficient of thermal expansion materials such as Invar or Cervit. A temperature stability of one Centigrade degree or better can easily be maintained using standard thermo-electric coolers which allow fixed wavelength stability over the long term operation of the device.

In one embodiment of the present invention, an active cavity includes an undoped gain region sandwiched between a substantially fully (nominally 100%) reflective bottom Bragg mirror and an intermediate partially reflecting Bragg mirror which is formed on a bottom or lower surface of a supporting substrate. The bottom mirror is preferably in direct thermal contact with an external heat sink for maximum heat removal effectiveness. A third mirror is placed external or adjacent to the substrate directly opposite the intermediate Bragg mirror. Alternatively, the intermediate Bragg mirror may be removed and the entire optical cavity would be an active cavity comprised of the bottom, fully reflective Bragg mirror and the mirror that is external to the substrate or formed directly on the substrate on the opposite side of the 100% Bragg mirror and the gain region.

In another alternative embodiment, the fully reflective mirror may be grown on the substrate followed by the gain region and then an optional intermediate mirror. The output mirror is placed external to this structure to control the laser mode. In another embodiment, the external mirror may be a fully reflective mirror and the output mirror may be grown on the substrate followed by the gain region and an optional intermediate mirror. In this case, the output is taken out through the substrate.

In a preferred embodiment, an electrically excitable coupled-cavity VECSEL utilizes an n-type semiconductor substrate with a partially reflective intermediate reflector (preferably an n-type Bragg mirror) grown on a bottom surface of the substrate. An undoped gain medium is grown or positioned under the intermediate reflector, and a bottom reflector is grown or positioned under the gain medium, to thereby form an active cavity containing a gain region. The bottom reflector is preferably a p-type Bragg mirror, which is substantially fully reflective (e.g., having a reflectivity of almost 100%), which is soldered to or otherwise placed in thermal and electrical contact with an external heat sink. A passive cavity is formed by the partially transmitting intermediate cavity mirror grown on the bottom surface of the n-type substrate together with a partially transmitting output cavity mirror, positioned external to or on the upper surface of the substrate. The output mirror is positioned above the substrate at the opposite side of the p-type Bragg mirror and defines a passive cavity with the intermediate cavity mirror. This passive cavity is designed to force the laser to operate in the fundamental spatial mode at a single frequency. The passive cavity can be made up of a solid substrate such as GaAs or InP, for example, or can be air or other inactive material. Variation of the electrical excitation may then be used to further tune or select the frequency defined by the passive cavity.

In an alternative embodiment, the active cavity may be grown on top of a substrate. A substantially fully reflective mirror may be grown on the substrate, followed by a gain region grown on the fully reflective mirror, followed by a partially reflective intermediate mirror grown on the gain medium. A third output mirror is placed outside this structure to form an air gap cavity. Alternatively, the intermediate mirror may be omitted (or made to be essentially non-reflective. The optical cavity mode frequency may be selected by use of a Fabry-Perot spectral mode-selecting etalon placed in the passive air cavity, for example. This etalon may be adjusted to force the laser to operate in a single longitudinal mode of the laser as is well known in the art.

In accordance with the method aspects of the present invention, the gain medium is epitaxially grown on the bottom surface of the partially reflective intermediate mirror. The upper surface of the substrate is provided with an anti-reflective coating and an external output mirror configured to control the desired mode or modes of the laser energy resonating both in the passive cavity and in the active cavity. In one embodiment, temperature adjustments inside the active cavity are accomplished by controlling an injection current into the active cavity to thermally adjust the length of the active cavity. In the absence of an intermediate mirror, the active cavity is defined as that portion of the laser optical resonator cavity that contains the active gain region and the fully reflective mirror and the passive cavity is the rest of the optical cavity between the gain region and the external mirror. The Fabry-Perot resonance frequency of this active cavity will tune with temperature in a material system such as GaInAs operating near 980 nm, for example, at a rate of about 0.07 nm per degree Centigrade and will force the laser to operate at discrete wavelengths set by the passive cavity modes. Each mode will operate only as the Fabry-Perot wavelength is made to be nearly equal to the passive cavity frequency. The temperature-induced wavelength changes associated with the active cavity would only change or “pull” the resonant frequency of the passive cavity by about several tens of MHz per degree Centigrade. In addition, the laser frequency change due to the expansion of the cavity structure in the longitudinal direction will also restrict the frequency shift to only a few MHz per degree Centigrade for materials such as “super invar” or “cervit”. Such frequency shifts are small enough to have little effect on present DWDM communications system requirements.

Although the various embodiments described herein utilize electrical excitation and an n-type doped substrate, many aspects of the invention are also applicable to optical or electron beam excitation, and to the use of n-type materials for the Bragg mirrors at both ends of the active cavity, with one or more Esaki diodes placed at resonant nodes of the laser field intensity inside the active cavity.

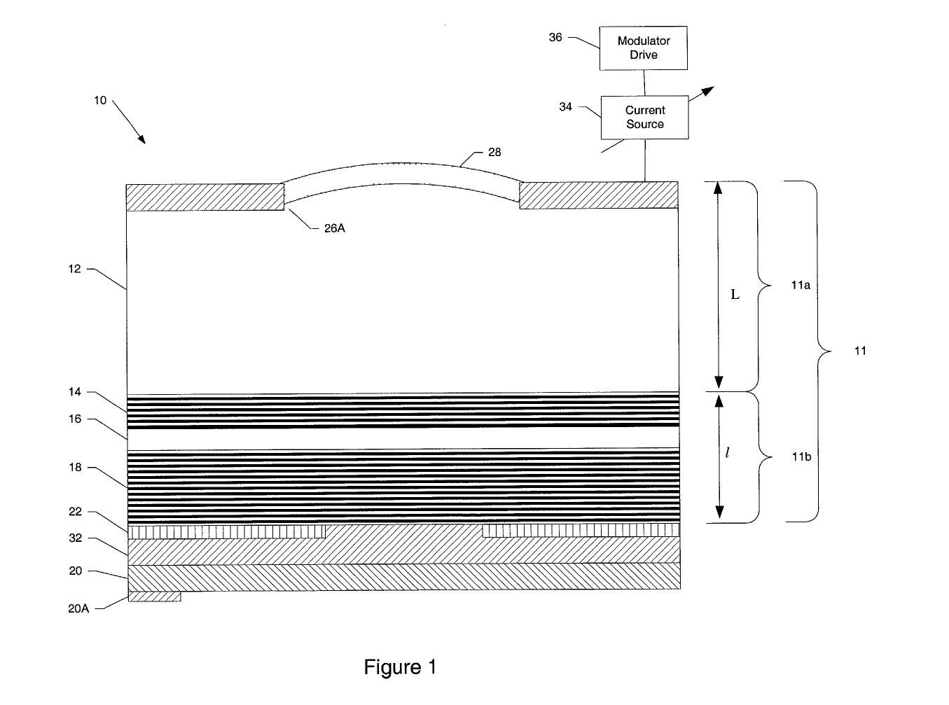

An embodiment of a coupled cavity VECSEL 10 according to the present invention is shown schematically in FIG. 1. The optical cavity 11 of the coupled cavity VECSEL 10 includes an active cavity 11b and a passive cavity 11a, including an n-type semiconductor substrate 12. The substrate 12 of the present invention should be sufficiently thick to be conveniently handled in wafer form during the manufacturing process and be sufficiently doped n-type to reduce the electrical resistance of substrate 12 to a value required for efficient operation and nearly uniform carrier injection across a current aperture region 22A at high power levels (so that an active gain region 16 is pumped uniformly without excessive carrier crowding), but without a corresponding sacrifice of the optical power extraction efficiency in the fundamental spatial mode due to optical absorption in the substrate at the laser wavelength. For purposes of explanation, the system may be made of materials such as GaAs/GaInAs, but the principles apply to other semiconductor based surface emitting lasers. For example, substrate 12 may be an optically transparent material such as silicon.

The length, L, of the passive cavity 11a may, as one example, be 50-100 microns for somewhat widely spaced cavity modes as compared to the ITU grid frequency separation of 100 GHz. To obtain a grid frequency separation of, for example, 100 GHz, the total length of the optical cavity 11 (L+l) in cm is, for example, about equal to 0.15/n, where n is the refractive index of the semiconductor material that is dominated by the substrate. For GaAs substrate material at a wavelength of about 980 nm, L is approximately 430 microns, for example. The actual length, L, can be controlled to position the fixed wavelength. The temperature of the entire device could be controlled to fine tune the absolute wavelength of the longitudinal modes. For devices operating in the 1.5 μm wavelength region, the thermal tuning rate would be about 35 GHz/degree C., and a temperature control of at least 0.1 degree for the device would be required to maintain the required absolute frequency. The cavity mode spacing should be large enough to insure single-frequency operation of the device. However, in another embodiment, the longitudinal mode spacing of the passive cavity can be chosen to be equal to the ITU grid spacing of 100 GHz, 50 GHz or 25 GHz, for example.

An intermediate reflector 14 is formed on a first (as illustrated, the bottom) surface of the n-type substrate 12. The intermediate reflector 14 may be epitaxially grown on the substrate 12 or it may be positioned or bonded onto the substrate 12 by various techniques well known in the semiconductor art. In an exemplary embodiment, intermediate mirror 14 is an n-type Bragg reflector built up of 8 to 18 pairs of GaAs/AlAs layers doped with n-type dopants, such as silicon, at a concentration of approximately 2-3×10⁻¹⁸ cm⁻³ and can be grown by using metallo-organic chemical vapor deposition (MOCVD) or molecular beam epitaxy (MBE) growth techniques that are well know in the art, to thereby produce a reflectivity of about 90-95%. A typical reflectivity range would be from 80-98%, although it could vary from near zero to more than 99%, depending on the specific application. In general, it should be as high as possible without permitting sufficient gain to occur in the active cavity 11b to produce stimulated emission without any feedback from the passive cavity 11a or to provide enough feedback to allow higher order modes to oscillate. Alternative mirror designs that involve the use of graded alloy compositions at the quarter wave layer interfaces and/or spike doping to reduce the resistance to carrier transport from Schottky barriers may also be implemented as is known in the art.

A gain region 16 is epitaxially grown or positioned on the lower surface (the side facing away from substrate 12) of the intermediate reflector 14. The gain region 16 is made of multiple-quantum-well III-V compound materials, such as GaInAs, that are well known in the art. In general, the more quantum wells in the gain region 16 the higher the single pass stimulated gain of the VECSEL 10 will be. However, strain compensation in the gain region 16 containing GaInAs wells are usually required for more than three quantum wells to avoid excessive strain that will potentially generate various defects.

A substantially fully reflective p-type Bragg mirror 18 is epitaxially grown or otherwise positioned on the gain region 16 at the opposite side to the substrate 12. Preferably, the p-type Bragg mirror 18 is fully reflective, with a reflectivity above approximately 99% and is formed by more than 30 pairs of quarter wavelength stacks of GaAs/AlAs (or alloy compositions of GaAlAs) layers doped with p-type dopants, such as zinc, carbon, or beryllium, at a concentration of approximately 2-3×10¹⁸ cm-³. The fully reflective mirror 18, may be epitaxially grown by using MOCVD or MBE techniques that are well known in the art. In an alternative embodiment, the fully reflective mirror 18 can also be spatially doped in a narrow region at the quarter wave interfaces with carbon at a concentration of approximately 1×10¹⁹ cm⁻³ to reduce the electrical impedance of the fully reflective mirror 18 by reducing the effects of localized heterostructure junctions at the quarter wave interfaces within the fully reflective mirror 18. In addition, well-known techniques of grading of the alloy near the interfaces as well as lowering the doping near the gain region and increasing the doping away from the gain region will lower the electrical resistance as well as lower the optical loss to improve the device operating efficiency.

An insulating dielectric layer 22 such as silicon nitride or silicon dioxide is preferably provided on the fully reflective mirror 18 and has a generally circular limiting aperture 22A formed therein through which an excitation current, I, required to operate the device is injected. Alternatively, a proton-implanted region contained in the p-mirror may be used to provide the current injection aperture. A layer of metallization 32 is formed or otherwise deposited on the lower surface of the insulating layer 22 and, through the aperture 22A, contacts the lower surface of the fully reflective mirror 18, as shown in FIG. 1. The metallization layer serves as the lower electrode 32 of the present device. The aperture 22A is therefore an effective diameter of the lower electrode 32 for the purpose of providing pump energy into the active cavity. The actual diameter of the laser gain region can be larger than the current aperture diameter due to the lateral carrier transport, diffusion, and optical excitation diffusion. Intermediate reflector 14, gain region 16 and bottom reflector 18 cooperate to define an active cavity 11b b having a cavity length l at the wavelength of interest (this wavelength is determined by the Fabry-Perot resonance frequency of the active cavity and will select the longitudinal mode of the optical cavity 11 and therefore the output wavelength of the device).

The effective length of the active cavity 11b includes the length determined by the decay of the optical field in each mirror. Since this Fabry-Perot wavelength tunes with temperature at the rate of about 0.07 nm per Centigrade degree for GaInAs type devices operating in the 980 nm wavelength region, a heat sink, 20, or other suitable temperature control means is provided which is in thermal contact with the lower surface of the lower electrode 32 to insure the wavelength stability of the device. In the preferred embodiment, the heat sink 20 can be formed of beryllia, copper, silicon, diamond, or other heat-conducting material and includes a conductive electrode 20A.

An additional metalization layer, 26 that also functions as an electrode is formed on the upper surface of substrate 12, as shown in FIG. 1. The electrode 26 may be connected to an adjustable current source 34 for providing an injection current to the laser device 10. The current source 34 may be additionally controlled by an external modulator drive 36 for modulating the injection current. The top electrode, including a circular optical aperture 26A, could cover the entire top surface of the substrate 12. The aperture 26A for emission of the laser beam is co-axially aligned with the bottom current aperture 22A. Optical aperture 26A is preferably substantially larger than the diameter 22A of lower electrode 32, to effectively eliminate any loss due to aperturing of the laser mode.

An output mirror 28 may be formed directly on the substrate 12 and may be formed by a dielectric mirror or by an n-type Bragg mirror having a reflectivity in the above-mentioned range. The n-type Bragg output mirror 28 can be monolithically grown as a semiconductor Bragg reflector on the upper surface of the substrate 12. Prior to the growth of the output mirror 28, the upper surface of the substrate 12 can be etched by conventional etching techniques to form an appropriately shaped surface. A dielectric mirror can alternatively be deposited on the etched surface or the natural reflectivity of the substrate material can be used to form a concave mirror output coupler. Alternatively, the equivalent of a curved mirror may be formed by application of a digital optical pattern on the top aperture together with dielectric coating. These techniques are particularly applicable to wafer scale processing for low cost manufacturing.

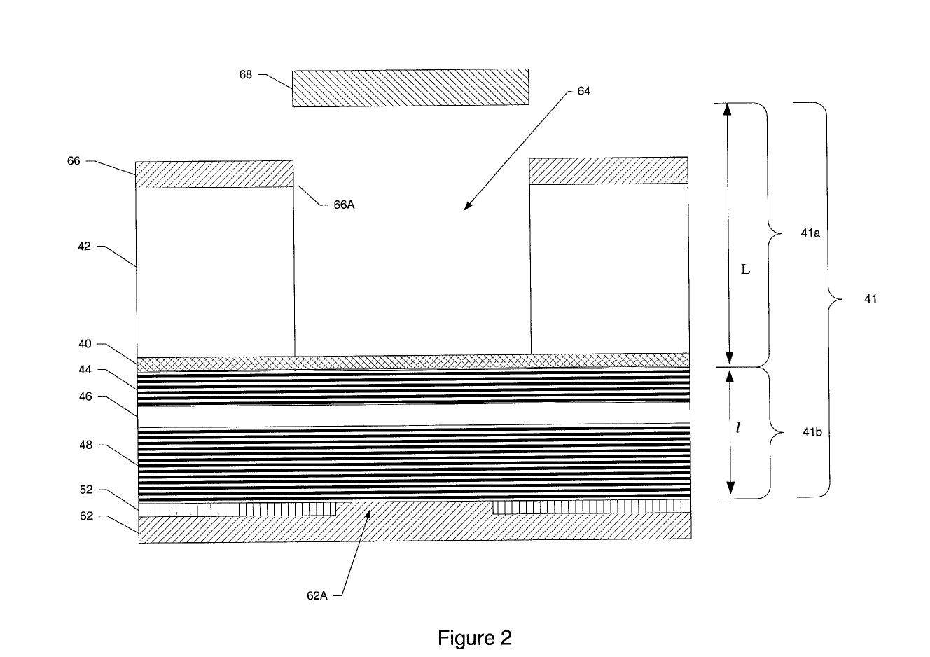

As another option, a polarizing element that selectively favors a desired polarization orientation may be included within the passive cavity 11a. Such a polarizing element may be in the form of a grid of conductive lines located substantially away from a node of the optical energy resonating within the passive cavity to thereby absorb polarization parallel to those lines, and may be conveniently formed on the upper surface of the substrate adjacent to the output mirror 28. As mentioned, the output mirror 28 can be either a discrete mirror held and aligned to form an external cavity (see FIG. 2) or it can be fabricated directly onto a semiconductor substrate made from GaAs or InP, for example, (FIG. 1).

The modulation speed of such an extended cavity is determined by the response time of the cavity. This time is related to the cavity relaxation time, T_{c}, which depends largely on the length of the cavity and mirror reflectivities (approximately 10⁻¹⁰ sec for typical devices), and the stimulated emission rate, Tₛ, in the gain region 16. The laser response time is given as

T˜(Tₛ T_{c})^{½} (1)

In the case of a device that has a long cavity length comprised primarily of air with a length of about 300 to 400 μm and a middle mirror reflectivity of about 90% and an output mirror reflectivity of about 75%, the device could be modulated at a rate of approximately 10 GHz.

Referring now, more specifically, to FIG. 2 there is illustrated an alternative embodiment of the present invention wherein the passive cavity is primarily comprised of air. As is therein shown, a layer of n⁺-GaAlAs, 40, is formed on the lower surface of an n-GaAs substrate 42 before an intermediate reflector 44 (e.g., an n-Bragg reflector) is formed. The remaining portions of the structure, that is, a substantially fully reflective mirror 48 (e.g., a p-Bragg reflector), an insulating dielectric layer 52, a metallization layer 62, and a quantum well gain structure 46 may be the same as illustrated and described with respect to FIG. 1 above and thus, will not be repeated herein.

After formation of the structure generally as shown in FIG. 2 with the addition of the layer 40, the substrate 12 is etched to provide the air cavity region 64. An output coupler in the form of an external output mirror 68 is provided in the alternative embodiment as shown in FIG. 2. The output mirror 68 may be, and is preferably, a dielectric mirror constructed from glass or similar such optically transparent material. The output mirror 68 is rigidly fixed and therefore the cavity length is rigidly fixed in relation to the laser gain element region 46 to maintain the absolute value of the laser operating frequency. The optical cavity 41 is comprised of an active cavity 41b of length l and a passive cavity 41a of length L. Through the utilization of the output mirror 68, the unloaded or passive cavity 41a of length L is defined by the distance between the intermediate mirror 44 and the lower surface of the output coupler mirror 68. The absolute frequency of the modes of the passive cavity can be adjusted by moving the mirror position by a fraction of a wavelength of the laser frequency. This may be accomplished by first aligning the laser mirror 68 to have the laser operate and then causing incremental longitudinal movement of mirror 68. Similar micro-movement has been used in aligning the position of a single-mode optical fiber to couple a laser beam into the fiber core.

In one method, a mirror mount assembly containing an output coupler mirror that is pre-aligned with the gain element of a surface-emitting laser is used to force the laser to operate in the fundamental spatial mode. Once this has been done, a force can be applied to move the mirror longitudinally along the axis of the laser cavity, thereby tuning the output of the single-frequency laser. A wave-meter may be used to monitor the output wavelength during this process. Once the desired wavelength is achieved, a laser welder securely bonds a slide arm connected to the mirror mount to weld the arm rigidly in place. The change in angle of the output coupler that occurs in this process is quite small and would not significantly alter the output of the laser. A typical adjustment using this method may be, for example, to manipulate the position of the output mirror on the order of 0.5 microns or less.

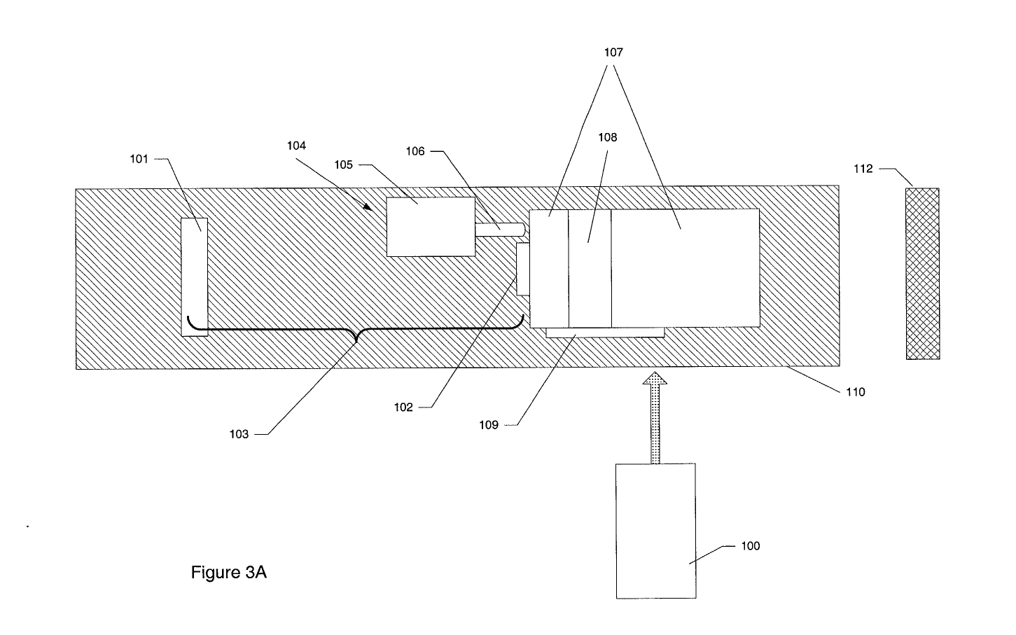

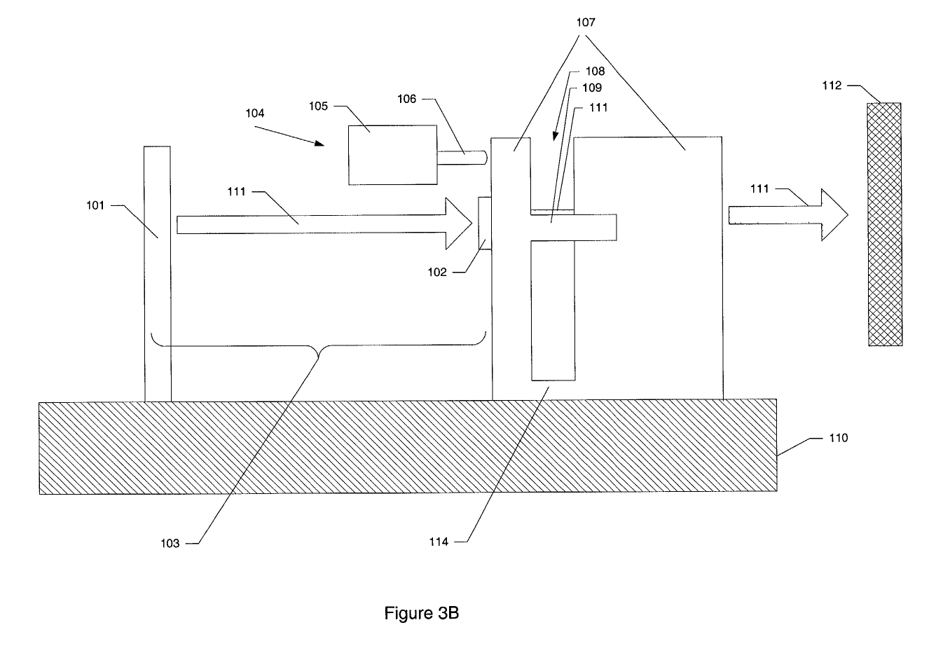

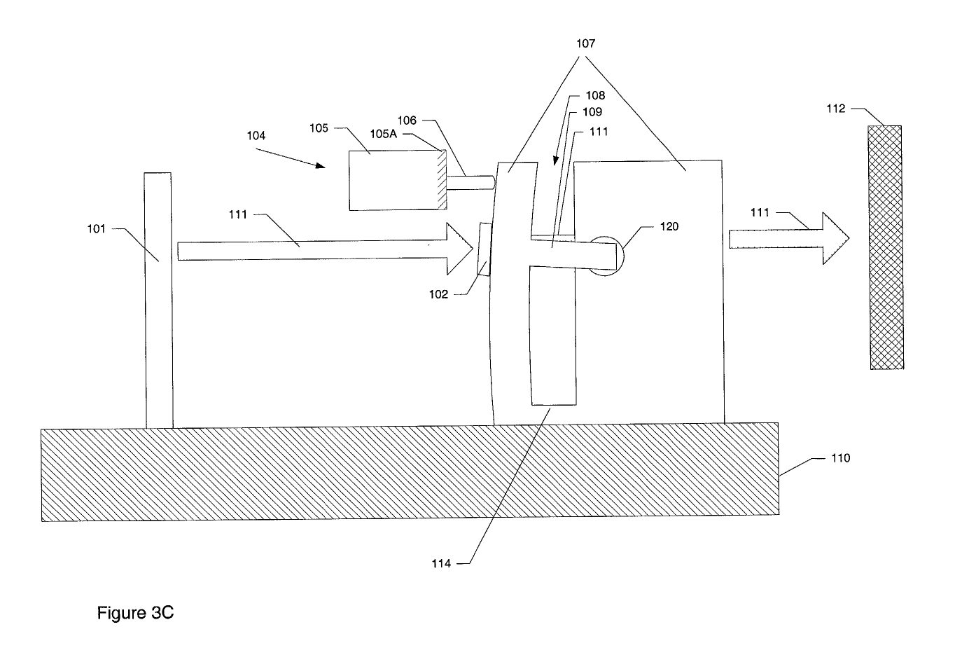

FIGS. 3A and 3B show a top view and a side view, respectively, of an example of a mirror mount assembly that may be employed to tune a laser output by adjusting and then fixing the position of an output mirror. In this example, a laser device 101 is aligned with an output coupler mirror 102. The output coupler mirror 102 is mounted in a housing 107, which is supported by a base 110. The housing 107 includes a flexure mount 114, with a gap 108 between portions of the housing 107. A slide arm 109 extends across the gap 108.

Once the laser 101 is aligned with the output mirror 102, a light beam 111 from the laser will travel through the output mirror (a portion of the light beam will also be reflected back into the laser 101). A wavelength meter 112 may be used to detect the wavelength of the laser beam 111. The wavelength meter 112 may be, for example, a standard, commercially available wavelength meter of the type available from Burleigh Instruments, Inc., Fishers, N.Y. An actuator 104 may be used to provide micro motion to adjust the position of the external lens 102, and thereby the length of the laser optical cavity 103. In the example shown in FIGS. 3A, 3B, the actuator 104 includes a region of piezoelectric material 105, a contact rod 106. The actuator may be, for example, of the type available from Newport Corporation of Irvine, Calif. A laser welder 100 may be aimed at a junction between the slide arm 109 and the housing 107. The laser welder may be, for example, of the type available from the Unitek Miyachi Corporation, Monrovia, Calif.

The system shown in FIGS. 3A and 3B may be used to tune a laser as shown in FIG. 3C. The laser 101 and output mirror 102 are initially mounted on the base 110 in an approximate configuration selected to set a selected distance between optical cavity mode frequencies (e.g., the 100 GHz designated as the ITU grid frequency separation distance). The laser 101 is then made to operate to output a light beam 111, which is detected by the wavelength meter 112. Once the wavelength of the light beam 111 is determined, a voltage may be applied to the piezoelectric material 105 to adjust the length of the material and thereby adjust the position of the output mirror 102. As shown in FIG. 3C, an expanded length of the piezoelectric material 105A, caused by the applied voltage, causes the contact rod 106 to press on the portion of the housing 107 that holds the output mirror 102. The resulting micro motion of the housing portion about the flexure mount 114 is shown greatly exaggerated in FIG. 3C for purposes of illustration. Once the wavelength meter 112 indicates that a desired wavelength output is reached, the laser welder may be activated to weld or solder the slide arm 109 to the housing 107 at weld spot 120. This will fix the position of the output mirror 102.

In an alternative embodiment, a laser welder is aimed at various points where the output mirror holder is connected to an output mirror mount in order to selectively melt portions of the mirror mount. When these areas are melted, the position of the mirror is manipulated as the melted material flows or evaporates. This material may include various types of solder, for example. In this manner, the position of the output mirror may be manipulated until the desired wavelength of the output beam is reached, as indicated by the wavelength detector.

In either event, by balancing the ratio of the passive cavity length L to the active cavity length l a device having a very low chirp is provided while at the same time maintaining absolute wavelength control and direct modulation at high frequency. As the external cavity length l gets longer (for a fixed active cavity length), the chirp decreases because the degree to which the external cavity locks the frequency corresponds to the ratio of the lengths of the cavities. The longer the passive cavity 41a however, the slower the modulation of the laser that is possible due to the longer cavity lifetime. If the external passive cavity is too short, however, modulation will be faster, but chirp will increase in the device. It has been determined that the balance between the passive to active cavities is optimized when the ratio of the passive cavity length to the active cavity length is from approximately 10:1 to 10,000:1. Thus, the response time for a 1 mm extended passive cavity length L in air in a device with approximately 1 μm active cavity length would allow digital pulse modulation rates of at least 10 Gbits/second, for instance, with a chirp that is substantively less than the transform limited spectral spread associated with the temporal width of the optical laser pulse itself.

The dc electrical current used to drive the laser will produce a temperature change in the gain region 46 that will alter the length of the active cavity and thereby shift the cavity resonance frequency. The magnitude of this shift is given by

$$d f = \frac{f}{n} ( \frac{ⅆ n}{ⅆ T} ) Δ T \qquad ( 2 )$$

where f is the center frequency of the active cavity mode, n is the refractive index in the gain region 46, dn/dT is the change in refractive index with temperature at the wavelength of interest, and ΔT is the temperature change of the effective gain region 46. For instance, a temperature change of 30 degrees Centigrade and a dn/dT of approximately 2×10⁻⁴, Δf will discretely tune over about 3 each of 100 GHz spaced WDM channels as defined by the passive cavity modes at a wavelength of 1.5 μm. The absolute change in the laser output frequencies from such a temperature variation would not be more than a few GHz over this temperature range. This allows very precise control of the fixed frequencies to the ITU grid. Conversely, temperature control of the device of only a few degrees insures that the output remains in a single frequency with better than about one GHz of absolute stability. An array of such devices made up of subgroups of devices with each subgroup selected from a different wafer designed to operate at a different center wavelength could provide a very broad range of selectable channels for low or controlled chirp WDM applications.

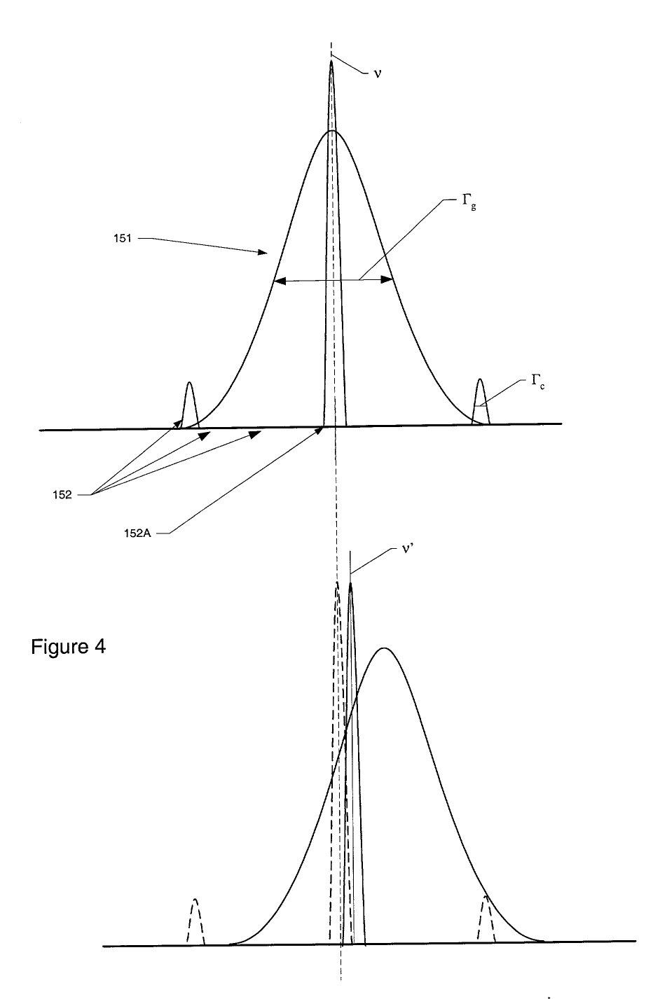

The actual lasing frequency of the device can be determined from the following expression

$$ν = \frac{{ν}_{l} {Γ}_{s} + {ν}_{s} {Γ}_{l}}{{Γ}_{s} + {Γ}_{l}} \qquad ( 3 )$$

where v₁ is the center frequency of the long passive cavity mode (e.g., the peak of curve 152A, as shown in FIG. 4), vₛ is the center frequency of the active cavity Fabry-Perot mode (e.g., the peak of curve 151, as shown in FIG. 4). Γ₁ is the passive cavity response linewidth and Γₛ is the active cavity Fabry-Perot line width

FIG. 4 shows a pictorial representation of the possible resonant frequency responses of the passive and active cavities. These are the frequencies these cavities can support, based on the respective lengths of the cavities. Because the active cavity is much shorter than the passive cavity (the passive cavity is on the order of 10 to 10,000 times the length of the active cavity) the active cavity supports many more wavelengths. The cavity linewidths (i.e., the Γ for each cavity) depend on both the length of the cavity and the reflectivity of the mirrors of each cavity, according to the following formulae:

$${Γ}_{s} = \frac{π ( 1 - {R}_{s}^{1 / 2} ) c}{2 n {L}_{s} {R}_{s}^{1 / 4}} and {Γ}_{l} = \frac{π ( 1 - {R}_{l}^{1 / 2} ) c}{2 n {L}_{l} {R}_{l}^{1 / 4}} \qquad ( 4 )$$

where the R's are the respective cavity end mirror reflectivity values (assuming both share a 100% reflector as the other mirror), and the v's are the respective cavity frequencies. The frequency change or chirp of the actual laser output is approximated by the expression:

$$\frac{δν}{{δν}_{s}} \sim \frac{1}{1 + ( \frac{{R}_{s}^{1 / 4} ( 1 - {R}_{l}^{1 / 2} )}{{R}_{l}^{1 / 4} ( 1 - {R}_{s}^{1 / 2} )} ) ( {L}_{l} / {L}_{s} )} \qquad ( 5 )$$

where δv is the change or chirp of the laser frequency, δvₛ is the change (“chirp”) characterizing the active (“short”) cavity frequency, Rₛ is the short cavity mirror reflectivity, R₁ is the passive (“long”) cavity mirror reflectivity, the first mirror being substantially equal to 100% reflectivity, Lₛ is the short cavity length and L_{c} is the long cavity length. In the case where the intermediate mirror reflectivity approaches zero, the chirp is reduced by the ratio of the long cavity length to the short cavity length.

Any individual mode frequency can be adjusted and locked by use of an intracavity Fabry-Perot etalon made from an optically transparent material, such as quartz, glass, silicon, and the like. Alternatively, a thin (compared to the wavelength of the laser light) metallic film deposited on a flat transparent material placed in the passive laser cavity will short the electric field of the laser and suppress the operation of all longitudinal modes except for one.

In conventional edge-emitting diode lasers, the effects of index dispersion will significantly change the spacing of the cavity modes over the gain bandwidth of the conventional device. The magnitude of the dispersion of the edge-emitting diode laser is largely due to the fact that the laser is operating at or very near its optical bandgap. In contrast, the resonant cavity of the present invention is mostly comprised of lower dispersion materials such as air or GaAs or InP, for example, where the laser wavelength is not as close to the optical bandgap. Therefore, the magnitude of the dispersion of the present invention is lower than that of a conventional edge-emitting diode laser.

In addition to the substantial reduction of the chirp by use of a passive cavity structure, an electro-optical modulator may be inserted into the unloaded portion of the laser resonator in order to control the optical length of the laser resonator during the laser pulse. For applications in which transmission in a fiber with significant dispersion, an optical pulse with the appropriate chirp would allow compensation of the pulse spreading. A sinusoidal electric field applied to the electro-optic modulator would provide the appropriate chirp when the laser pulse occurs during the portion of the electrical pulse in which the voltage is decreasing. By adjusting the timing, the voltage change could approach a more linear region. In such a case, the data rate is reduced since no pulses will be used during the increasing voltage portion of the modulator drive.

From the foregoing, it will be appreciated that, although specific embodiments of the invention have been described herein for purposes of illustration, various modifications may be made by persons skilled in the art without deviating from the spirit and/or scope of the invention. Specifically, the temperature control in the gain regions or in the GaAs materials of the laser devices may be accomplished by various techniques suitable to provide precise temperature adjustments. The dimensions and doping levels of various regions of the devices may also be modified to accomplish optimum performance for various applications. The reflectivity of the intermediate reflector 14, the p-type Bragg mirror 18 and the output mirror 28 may also be adjusted to accomplish optimum performance results. These devices may be electrically, optically, or electron beam pumped. In addition, this scheme may be applied to edge-emitting lasers having short optical gain lengths of, e.g., less than 100 μm. In this case, a small lens may be required to adjust the divergence of the laser beam in the cavity to form a stable resonator. Alternatively, a concave mirror can be used to form the optical resonator cavity.

What is claimed is:

1. A reduced-chirp semiconductor laser device comprising:
an active cavity including an active gain region disposed between a first mirror and a second mirror, and characterized by an active cavity chirp value; and
a passive cavity including a substantially optically transparent passive cavity material disposed between the second mirror and a third mirror, wherein
the third mirror reflectivity and the passive cavity length are adapted to reduce a chirp of the laser device by substantially at least a factor of two over the active cavity chirp value.

2. A semiconductor laser device as defined in claim 1, wherein the passive cavity length is further adapted so that the response time of the laser device is below a selected value.

3. A semiconductor laser device as defined in claim 1, wherein the passive cavity material is air.

4. A semiconductor laser device as defined in claim 1, wherein the third mirror is an external output mirror.

5. A semiconductor laser device as defined in claim 1, wherein the laser device is a vertical cavity surface emitting laser device.

6. A semiconductor laser device as defined in claim 1, wherein the laser device is an edge-emitting laser device.

7. A semiconductor laser device as defined in claim 4, wherein the position of the external output mirror defines a selected wavelength of the generated light.

8. A semiconductor laser device as defined in claim 4, wherein a position of the external output mirror can be set to fix a wavelength of light output from the semiconductor laser device.

9. A semiconductor laser device as defined in claim 8, wherein the position of the external output mirror is initially adjustable in order to select a wavelength of the light output from the device, and is subsequently fixed when a selected wavelength is achieved.

10. A semiconductor laser device as defined in claim 1, wherein the chirp of the laser device is substantially characterized by the following equation:
$$\frac{δν}{{δν}_{s}} \sim \frac{1}{1 + ( \frac{{R}_{s}^{1 / 4} ( 1 - {R}_{l}^{1 / 2} )}{{R}_{l}^{1 / 4} ( 1 - {R}_{s}^{1 / 2} )} ) ( {L}_{l} / {L}_{s} )}$$
where δv is the chirp of the laser device, δvₛ is the active cavity chirp, Rₛ is the reflectivity of the second mirror, R₁ is the reflectivity of the third mirror, Lₛ is the length of the active cavity, and L_{c} is the length of the passive cavity; and wherein
the first mirror is substantially fully reflective.

11. A method for reducing chirp in a semiconductor laser device having an active cavity including an active gain region disposed between first and second mirrors, comprising the steps of:
providing a third mirror with a third mirror reflectivity;
positioning the third mirror a selected distance from the active cavity, wherein the third mirror reflectivity and the distance of the third mirror from the active cavity are selected to reduce a chirp of the laser device below a selected value.

12. The method of claim 11, wherein the third mirror reflectivity and the distance of the third mirror from the active cavity are further selected to maintain the laser device response time below a selected value.

13. A method for setting a wavelength of a light beam output from a controlled chirp semiconductor laser including an active cavity and a passive cavity including an output mirror, comprising the steps of:
selecting a desired light beam wavelength;
operating the laser to output a light beam;
detecting a wavelength of the output light beam;
selecting a location for the output mirror by manipulating a position of the output mirror to adjust the ratio of the passive cavity length to the active cavity length to adjust the wavelength of the output laser beam until the output laser wavelength is substantially equivalent to the selected output wavelength;
fixing the output mirror at the selected location.

14. The method of claim 13, further comprising the following steps:
defining a set of discrete wavelengths and spatial modes by selecting the longitudinal length of the passive cavity; and
changing the refractive index of the active cavity by thermally adjusting the longitudinal length of the gain medium.

15. The method of claim 14, further comprising the following steps:
directing an injection current into the gain medium to stimulate optical emission in the gain medium; and
controlling the current level of the injection current to thermally adjust the longitudinal length of the gain medium.

16. The method of claim 15, further comprising a step of controlling a temperature of a heat sink coupled to the laser to control the temperature in the gain medium for thermal modulation of the longitudinal length of the gain medium.

17. The method of claim 14, wherein the step of thermally adjusting the longitudinal length of the active cavity includes controlling a temperature of a heat sink coupled to the laser to control a temperature in the gain medium.

18. The method of claim 13, further comprising a step of placing a mode selecting etalon in the passive cavity to select and control a wavelength of a single longitudinal mode of the laser.

19. The method of claim 13, further comprising a step of placing an electro-optical element in the passive cavity to impose a controlled chirp on an output pulse.

20. The method of claim 13, wherein an actuator is used for manipulating the position of the output mirror.

21. The method of claim 20, wherein the actuator includes a piezoelectric material.

22. The method of claim 13, wherein a laser welder is used for fixing the output mirror at the selected location.

23. A method for making a wavelength selectable, controlled chirp semiconductor laser comprising the steps of:
creating on a substrate an active cavity including a gain region disposed between a substantially fully reflective mirror and a partially reflective mirror;
creating a passive cavity, including an external output mirror, coupled to the active cavity to control a chirp of the active cavity;
selecting a desired output light beam wavelength;
operating the laser to output a light beam;
detecting the wavelength of the output light beam;
selecting a position of the output mirror by manipulating the position of the output mirror to adjust the ratio of the passive cavity length to the active cavity length to adjust the wavelength of the output laser beam until the laser outputs the selected output wavelength;
fixing the output mirror at the selected position.

24. The method of claim 23, further comprising the steps of:
selecting a passive cavity length and external output mirror reflectivity to reduce a chirp of the laser by substantially at least a factor of two over an active cavity chirp value.

25. The method of claim 24, further comprising the steps of:
selecting a passive cavity length and external output mirror reflectivity to maintain a response time of the laser below a selected value.
